(19) United States
(12) Patent Application Publication
(10) Pub. No.: US 2012/0294921 A1
(43) Pub. Date: Nov. 22, 2012

(54) ANTIBACTERIAL AGENT AND METHOD OF PREPARING THE SAME

(76) Inventors: Xiaozhong HUANG, Changsha (CN); Hongyu LONG, Changsha (CN); Ping XIANG, Changsha (CN); Yi YANG, Changsha (CN); Zuojuan DU, Changsha (CN); Liyu CHEN, Changsha (CN)

(21) Appl. No.: 13/559,639

(22) Filed: Jul. 27, 2012

Related U.S. Application Data
(63) Continuation-in-part of application No. PCT/CN2011/000112, filed on Jan. 24, 2011.

(30) Foreign Application Priority Data
Jan. 27, 2010 (CN) 201010300826.1

(51) Int. Cl. A01N 25/34; A01P 1/00; A01N 59/16

(52) U.S. Cl. 424/405; 424/641

(57) ABSTRACT

An antibacterial agent including a photocatalytic antibacterial material. The photocatalytic antibacterial material includes a rare-earth element modified tetrapod-shaped zinc oxide whisker (T-ZnOw). A method for preparation of the antibacterial agent is also provided, and includes: 1) adding a tetrapod-shaped zinc oxide whisker and a dispersant into a dispersion medium, and dispersing to yield a tetrapod-shaped zinc oxide whisker dispersion system; and 2) adding a rare-earth element to the dispersion system under ultrasound conditions, stirring, performing ultrasonic vibration, filtering, washing, drying, and baking, to yield the antibacterial agent.

### CROSS-REFERENCE TO RELATED APPLICATIONS

This application is a continuation-in-part of International Patent Application No. PCT/CN2011/000112 with an international filing date of Jan. 24, 2011, designating the United States, now pending, and further claims priority benefits to Chinese Patent Application No. 201010300826.1 filed Jan. 27, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

This invention relates to a T-ZnO whisker antibacterial agent and method of preparing the same.

2. Description of the Related Art

Conventional inorganic antibacterial materials include two types: silver-led dissolving type inorganic antibacterial material and titanium-zinc-led photocatalytic antibacterial material. The silver ion in a silver antimicrobial material has strong antibacterial activity, but the chemical property of the silver ion is more active, the silver ion is sensitive to heat and light and easy to form black silver oxide especially after being exposed under ultraviolet radiation. Thus, the appearance of the white or light-color products is affected, and the stability has not been solved effectively and eventually for a long time. The photocatalytic antibacterial material has the advantages of non-toxicity, mild reaction condition, good selectivity, etc., and arouses extensive attention on the aspect of degradation of environmental pollutants, and the antibacterial material developed at present mainly includes nano-titanium dioxide and nano-zinc oxide. Studies of the influence of particle size of ZnO on the antibacterial activity showed that the antibacterial activity of ZnO is obviously enhanced along with the decrease of grain size within the range of 0.1-0.8 μm. Studies further showed that a tetrapod-shaped zinc oxide whisker (T-ZnOw) has better antibacterial activity than a general zinc oxide, has been successfully applied to various fields of antisepsis, mildew resistance, sewage treatment and harmful chemicals decomposition and has achieved good result. Because of its unique spatial structure, the tetrapod-shaped zinc oxide whisker as a novel photocatalyst not only overcomes the defects that the general silver inorganic antibacterial agent easily changes color, but also is different from the photocatalytic nano-antibacterial material with antibacterial property only by exposure of ultraviolet photocatalysis, and does not cause secondary pollution and other side effects caused by organic antibacterial agents. Such a material is expected to have a board application prospect in environmental protection, sewage treatment, air purification, etc.

### SUMMARY OF THE INVENTION

To overcome the current widespread problems of insufficient response in the field of visible light, short effective antibacterial time, and low utilization ratio of antibacterial agent in the photocatalyst, it is one objective of the invention to provide a T-ZnOw antibacterial agent modified by doping a rare-earth element, as well as a method of preparing the same. In the antibacterial agent, the rare-earth modified tetrapod-shaped zinc oxide whisker (T-ZnOw) is used as the photocatalyst, thus not only the catalytic activity of the photocatalyst can be enhanced, the response range of the photocatalyst in the field of visible light can be widened, the utilization ratio of visible light can be improved, but also the antibacterial property of the antibacterial agent can be enhanced.

To achieve the above objective, in accordance with one embodiment of the invention, there is provided an antibacterial agent comprising a photocatalytic antibacterial material, wherein the photocatalytic antibacterial material comprises a rare-earth element modified tetrapod-shaped zinc oxide whisker.

In a class of this embodiment, the antibacterial agent is powdery.

In a class of this embodiment, the rare-earth element is a non-radioactive rare-earth element, being La, Ho, Ce, Y, Pr, Gd, Dy, Eu, or a mixture thereof.

In a class of this embodiment, the antibacterial agent can be prepared by the following method: adding the tetrapod-shaped zinc oxide whisker and a dispersant into a dispersion medium, and dispersing to yield a tetrapod-shaped zinc oxide whisker dispersion system; adding a rare-earth element to the dispersion system under ultrasound conditions, stirring, performing ultrasonic vibration, filtering, washing, drying, and baking, to yield the rare-earth element modified T-ZnOw antibacterial agent.

In a class of this embodiment, raw materials for preparing the antibacterial agent is as follows:
a weight percent of the tetrapod-shaped zinc oxide whisker in the antibacterial agent is between 0.5 and 20%;
a weight percent of the rare-earth element doped in the tetrapod-shaped zinc oxide whisker is between 0.0010 and 1.0000%;
a weight percent of the dispersant in the antibacterial agent is between 0.01 and 40%; and
rest component is the dispersion medium.

The invention is suitable for preparing a rare-earth element modified T-ZnOw antibacterial agent. The addition of T-ZnOw is 0.5-20% by weight; the amount of doping the rare-earth element La, Ho, Ce, Y, Pr, Gd, Dy, Eu, or a mixture thereof to the T-ZnOw is 0.0010-1.0000% by weight. The chemical form of the rare-earth element is a chloride, oxide, sulfide, acetate, organic metal pure salt, etc. The dispersion medium can be deionized water, acetone, ethylene, or methanol. The dispersant can be PEG, titanate, polyacrylamide, sodium oleate, polyethylene, pyrrolone (K30), triethanolamine, or a mixture thereof, with addition amount of between 0.01 and 40% by weight.

The above-mentioned rare-earth element compound, acetic acid, ammonia liquor, sodium hydroxide, sodium carbonate, PEG, titanate, polyacrylamide, sodium oleate, polyethylene, pyrrolone (K30), and triethanolamine are commercially pure reagents or analytical reagents.

T-ZnOw is a photocatalytic antibacterial material, mainly making use of the natural light source at the ultraviolet light wavelength band. The problem of low utilization ratio of visible light can be well solved through material modification. The lattice defects are introduced in the T-ZnOw crystal through rare-earth element, or the crystallinity is changed, and an additional energy level is generated in the T-ZnOw forbidden band, thus the spectral response range of the T-ZnOw is widened, and the catalytic efficiency of the photocatalyst is greatly improved; on the other hand, the rare-earth element as a dispersant can enable the T-ZnOw to be evenly dispersed and suspended in the dispersion medium for a long time, and thus remarkably enhance the antibacterial property of the T-ZnOw.

Specifically, a method for preparing the antibacterial agent is as follows:

1. Preparation of T-ZnOw Dispersion System

Adding T-ZnOw in a dispersion medium of an organic solvent such as deionized water, acetone, ethanol and methanol; adjusting the pH value of the solution to 3-12 with acetic acid, ammonia liquor, sodium hydroxide, or sodium carbonate; adding a dispersant; and preparing a T-ZnOw dispersion system after 10-60 min' stirring and 10-30 min' ultrasonic vibration.

2. Doping of Rare-Earth Element

Adding one or more rare-earth elements in the T-ZnOw dispersion system under ultrasound conditions; obtaining a rare-earth modified T-ZnOw suspension system after 10-60 min' stirring and 10-30 min' ultrasonic vibration.

3. Filtering, washing, drying, baking (1 h-3 h at the temperature of 300-600° C.) and fully grinding the obtained rare-earth modified T-ZnOw suspension system to obtain a powdery product (i.e., rare-earth modified T-ZnOw antibacterial agent).

In a class of this embodiment, the dispersant is PEG, titanate, polyacrylamide, sodium oleate, polyethylene, pyrrolone (K30), triethanolamine, or a mixture thereof.

Advantages of the invention are summarized below:
1. In the process of simultaneously introducing the T-ZnOw and rare-earth element to the rare-earth modified T-ZnOw antibacterial agent at a certain ratio, a novel photocatalytic antibacterial agent with high sensitive responsiveness in the field of visible light, high utilization ratio, and high antibacterial property is obtained.
2. The characteristics of the tetrapod-shaped zinc oxide whisker and the rare-earth element are fully utilized. The tetrapod-shaped zinc oxide whisker has more active centers than nano-titanium dioxide and nano-zinc oxide, thus it has higher photocatalytic activity; the rare-earth element has good antibacterial property, has a synergistic antibacterial effect after being combined with the tetrapod-shaped zinc oxide whisker, possess a higher ability to kill some common pathogenic microorganisms and may have wider antibacterial spectrum.
3. The rare-earth element can generate an additional energy level in the T-ZnOw to widen the spectral response range, the T-ZnOw is modified using the rare-earth element, and the modified T-ZnOw has high sensitive responsiveness in the field of visible light, thus the application range of the T-ZnOw is widened.
4. The T-ZnOw can be evenly dispersed and suspended in the dispersion medium for a long time by using the rare-earth element as the dispersant, and the high antibacterial property is realized by prolonging the effective acting time of the composite T-ZnOw antibacterial agent and improving the utilization ratio of the T-ZnOw.
5. The antibacterial agent is multipurpose, can be widely used in various fields such as food package, building materials, medical instruments, textiles, sanitary accessories, daily necessities, sanitary wares, household appliances, and communication materials, has huge potential commercial value, can be directly used as the antibacterial additive or coating, and is stable in property and little in toxic side effect.

### BRIEF DESCRIPTION OF THE DRAWINGS

FIG. 1 is a process flowchart of a method for preparation of an antibacterial agent in accordance with one embodiment of the invention; and

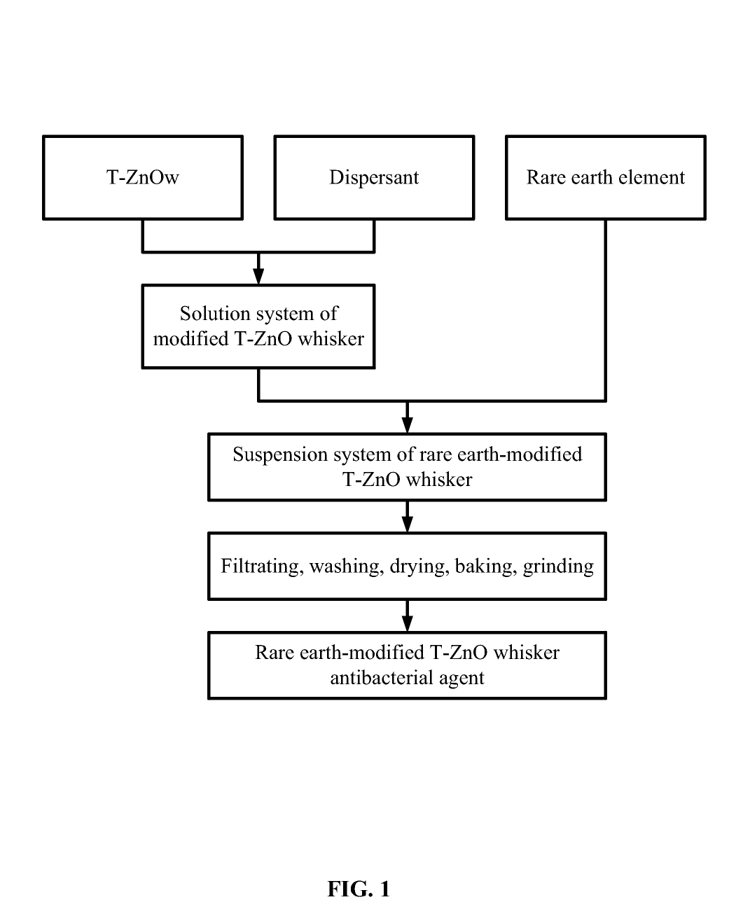

FIG. 2 is an SEM photograph of a T-ZnOw in accordance with one embodiment of the invention.

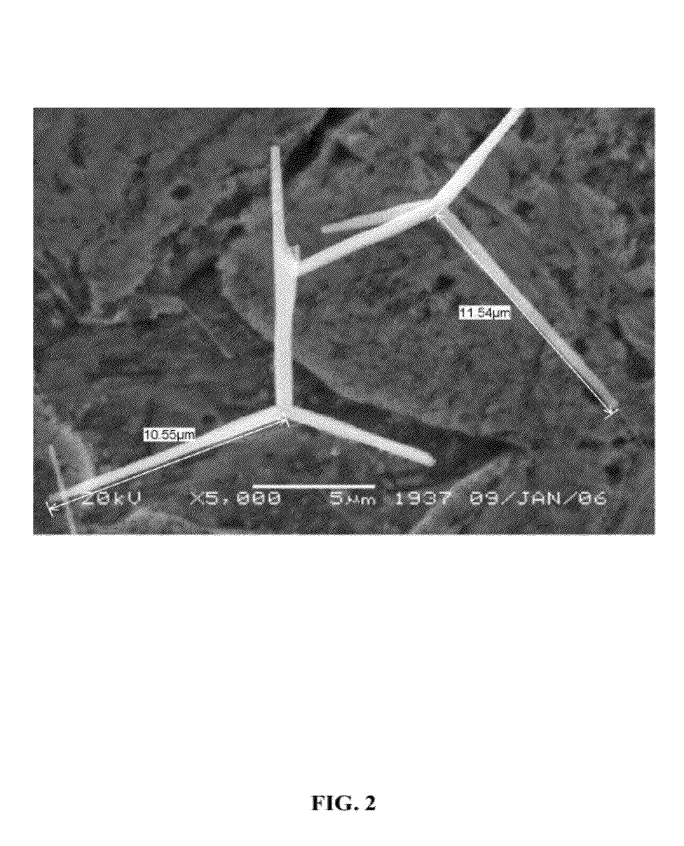

### DETAILED DESCRIPTION OF THE EMBODIMENTS

For further illustrating the invention, experiments detailing a modified T-ZnO whisker antibacterial agent and method of preparing the same are described below. It should be noted that the following examples are intended to describe and not to limit the invention.

### Example 1

LaCl₃, deionized water, polyacrylamide, and ammonia liquor are all analytical reagents.

1.000 g of T-ZnOw was put in a beaker, and deionized water was added to yield a 100 mL solution. The solution was stirred with 0.0500 g of polyacrylamide added. After another 20 min's stirring, ultrasonic vibration was carried out for 10 min. Thereafter, the pH value of the solution was adjusted to 9 with ammonia liquor to yield a dispersion system of T-ZnOw in the aqueous medium.

0.0250 g of LaCl₃ was added in the T-ZnOw dispersion system under ultrasonic conditions. The resulting solution was stirred for 40 min and then vibrated under ultrasonic wave for 20 min to yield a suspension. The suspension was filtered, washed, dried, baked (1 h at the temperature of 300° C.), and fully ground to yield a single rare-earth element modified T-ZnOw antibacterial agent.

### Example 2

LaCl₃, Cecl₃, deionized water, and PEG20000 are all analytical reagents.

0.5000 g of T-ZnOw was put in a beaker, and deionized water was added to yield a 100 mL solution. The solution was stirred with 0.0300 g of PEG20000 added. After another 30 min's stirring, ultrasonic vibration was carried out for 10 min to yield a dispersion system of T-ZnOw in the aqueous medium.

0.0500 g of LaCl₃ and 0.0500 g of CeCl₃ were added in the T-ZnOw dispersion system under ultrasonic conditions. The resulting solution was stirred for 40 min and then vibrated under ultrasonic wave for 20 min to yield a suspension. The suspension was filtered, washed, dried, baked (1 h at the temperature of 300° C.), and fully ground to yield a two rare-earth elements modified T-ZnOw antibacterial agent.

Experiments showed the MIC (minimal inhibitory concentration) of the rare-earth modified zinc oxide whisker antibacterial agent prepared according to the example to staphylococcus aureus can reach 300 ppm or below. The bactericidal rate against staphylococcus aureus can reach 90% or above under 1 hour's illumination of a fluorescent lamp (see Table 1).

TABLE 1
Raw materials, preparation technological conditions, and performances of rare-earth element modified T-ZnOw antibacterial agent

| | | | | | | | | | | Antibacterial test | |
|---|---|---|---|---|---|---|---|---|---|---|---|
| | Raw materials | | | | | Technology conditions | | | | | Bactericidal rate under |
| Experiment | Dispersion | | | | PEG | Magnetic | Ultrasonic | Drying | Drying | | 1 hour's illumination |
| content | medium | T-ZnOw | LaCl₃ | CeCl₃ | 20000 | stirring | vibration | temperature | time | MIC | of a fluorescent lamp |
| Antibacterial | Deionized | 0.50% | 0.05% | 0.05% | 0.03% | 40 min | 20 min | 300° C. | 1 h | 300 ppm | 91.7% |
| agent | water | | | | | | | | | | |

### Example 3

Ho₂O₃, EuCl₃, CeCl₃, acetone, and titanate are all analytical reagents.

2.000 g of T-ZnOw was put in a beaker, and titanate and acetone with a ratio of 1:2 were added to yield a 100 mL solution. The solution was stirred for 40 min, and vibrated under ultrasonic wave for 20 min to yield a dispersion system of T-ZnOw in the acetone medium.

0.0025 g of Ho₂O₃, 0.0050 g of EuCl₃, and 0.0025 g of CeCl₃ were added in the T-ZnOw dispersion system under ultrasonic conditions. The resulting solution was stirred for 60 min and then vibrated under ultrasonic wave for 20 min to yield a suspension. The suspension was filtered, washed, dried, baked (1.5 h at the temperature of 400° C.), and fully ground to yield a three rare-earth elements modified T-ZnOw antibacterial agent.

### Example 4

Holmium acetate, praseodymium acetate, GdCl₃, Eu₂O₃, alcohol, polyacrylamide are all analytical reagents.

1.000 g of T-ZnOw was put in a beaker, and alcohol was added to yield a 100 mL solution. The solution was stirred with 0.0500 g of polyacrylamide added. After another 40 min's stirring, ultrasonic vibration was carried out for 15 min to yield a dispersion system of T-ZnOw in the alcohol medium.

0.0250 g of holmium acetate, 0.0250 g of praseodymium acetate, 0.0250 g of GdCl₃, and 0.0250 g of Eu₂O₃ were added in the T-ZnOw dispersion system under ultrasonic conditions. The resulting solution was stirred for 40 min and then vibrated under ultrasonic wave for 20 min to yield a suspension. The suspension was filtered, washed, dried, baked (2 h at the temperature of 450° C.), and fully ground to yield a four rare-earth elements modified T-ZnOw antibacterial agent.

### Example 5

La₂O₃, HoCl₃, PrCl₃, gadolinium acetate, DyCl₃, methanol, and titanate are all analytical reagents.

1.000 g of T-ZnOw was put in a beaker, and methanol was added to yield a 100 mL solution. The solution was stirred with 10 mL of titanate added. After another 50 min's stirring, the pH value of the solution was adjusted to 8 with ammonia liquor to yield a dispersion system of T-ZnOw in the methanol medium.

0.0250 g of La₂O₃, 0.0250 g of HoCl₃, 0.0250 g of PrCl₃, 0.0250 g of gadolinium acetate, and 0.0005 g of DyCl₃ were added in the T-ZnOw dispersion system under ultrasonic conditions. The resulting solution was stirred for 40 min and then vibrated under ultrasonic wave for 20 min to yield a suspension. The suspension was filtered, washed, dried, baked (2 h at the temperature of 450° C.), and fully ground to yield a five rare-earth elements modified T-ZnOw antibacterial agent.

### Example 6

LaCl₃, holmium acetate, CeO₂, YCl₃, Pr₂S₃, Gd₂O₃, DyCl₃, Eu₂O₃, deionized water, PEG20000, and ammonia liquor are all analytical reagents.

2.000 g of T-ZnOw was put in a beaker, and deionized water was added to yield a 100 mL solution. The solution was stirred with 0.0500 g of PEG20000 added. After another 30 min's stirring, ultrasonic vibration was carried out for 30 min. Thereafter, the pH value of the solution was adjusted to 9 with ammonia liquor to yield a dispersion system of T-ZnOw in the aqueous medium.

0.0005 g of LaCl₃, 0.0005 g of holmium acetate, 0.0005 g of CeO₂, 0.0025 g of YCl₃, 0.0025 g of Pr₂S₃, 0.0010 g of GdO₃, 0.0005 g of Eu₂O₃, and 0.0005 g of DyCl₃ were added in the T-ZnOw dispersion system under ultrasonic conditions. The resulting solution was stirred for 40 min and then vibrated under ultrasonic wave for 20 min to yield a suspension. The suspension was filtered, washed, dried, baked (2.5 h at the temperature of 500° C.), and fully ground to yield a multiple rare-earth elements modified T-ZnOw antibacterial agent.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An antibacterial agent, comprising: a photocatalytic antibacterial material, wherein the photocatalytic antibacterial material comprises a rare-earth element modified tetrapod-shaped zinc oxide whisker (T-ZnOw).

2. The antibacterial agent of claim 1, wherein the antibacterial agent is powdery, and the rare-earth element is a non-radioactive rare-earth element, selected from La, Ho, Ce, Y, Pr, Gd, Dy, Eu, or a mixture thereof.

3. The antibacterial agent of claim 1, being prepared as follows:
1) adding a tetrapod-shaped zinc oxide whisker and a dispersant into a dispersion medium, and dispersing to yield a tetrapod-shaped zinc oxide whisker dispersion system; and
2) adding a rare-earth element to the dispersion system under ultrasound conditions, stirring, performing ultrasonic vibration, filtering, washing, drying, and baking, to yield the antibacterial agent.

4. The antibacterial agent of claim 2, being prepared as follows:
1) adding a tetrapod-shaped zinc oxide whisker and a dispersant into a dispersion medium, and dispersing to yield a tetrapod-shaped zinc oxide whisker dispersion system; and
2) adding a rare-earth element to the dispersion system under ultrasound conditions, stirring, performing ultrasonic vibration, filtering, washing, drying, and baking, to yield the antibacterial agent.

5. The antibacterial agent of claim 4, wherein raw materials for preparing the antibacterial agent is as follows:
a) a weight percent of the tetrapod-shaped zinc oxide whisker in the antibacterial agent is between 0.5 and 20%;
b) a weight percent of the rare-earth element doped in the tetrapod-shaped zinc oxide whisker is between 0.0010 and 1.0000%;
c) a weight percent of the dispersant in the antibacterial agent is between 0.01 and 40%; and
d) rest component is the dispersion medium.

6. The antibacterial agent of claim 4, wherein a chemical form of the rare-earth element is a chloride, oxide, sulfide, acetate, or organic metal pure salt.

7. The antibacterial agent of claim 4, wherein the dispersion medium is deionized water, acetone, ethylene, or methanol.

8. The antibacterial agent of claim 4, wherein the dispersant is PEG, titanate, polyacrylamide, sodium oleate, polyethylene, pyrrolone, triethanolamine, or a mixture thereof.

9. A method for preparation of an antibacterial agent, comprising:
1) adding a tetrapod-shaped zinc oxide whisker and a dispersant into a dispersion medium, and dispersing to yield a tetrapod-shaped zinc oxide whisker dispersion system; and
2) adding a rare-earth element to the dispersion system under ultrasound conditions, stirring, performing ultrasonic vibration, filtering, washing, drying, and baking, to yield the antibacterial agent.

10. The method of claim 9, wherein
a) a weight percent of the tetrapod-shaped zinc oxide whisker in the antibacterial agent is between 0.5 and 20%;
b) a weight percent of the rare-earth element doped in the tetrapod-shaped zinc oxide whisker is between 0.0010 and 1.0000%;
c) a weight percent of the dispersant in the antibacterial agent is between 0.01 and 40%; and
d) rest component is the dispersion medium.

11. The method of claim 9, wherein the rare-earth element is La, Ho, Ce, Y, Pr, Gd, Dy, Eu, or a mixture thereof, and a chemical form of the rare-earth element is a chloride, oxide, sulfide, acetate, organic metal pure salt.

12. The method of claim 10, wherein the rare-earth element is La, Ho, Ce, Y, Pr, Gd, Dy, Eu, or a mixture thereof, and a chemical form of the rare-earth element is a chloride, oxide, sulfide, acetate, organic metal pure salt.

13. The method of claim 9, wherein the dispersion medium is deionized water, acetone, ethylene, or methanol, and the dispersant is PEG, titanate, polyacrylamide, sodium oleate, polyethylene, pyrrolone, triethanolamine, or a mixture thereof.

14. The method of claim 10, wherein the dispersion medium is deionized water, acetone, ethylene, or methanol, and the dispersant is PEG, titanate, polyacrylamide, sodium oleate, polyethylene, pyrrolone, triethanolamine, or a mixture thereof.

15. The method of claim 9, wherein
a) adding the tetrapod-shaped zinc oxide whisker in the dispersion medium; adjusting the pH value of a resulting solution to 3-12 with acetic acid, ammonia liquor, sodium hydroxide, or sodium carbonate; adding the dispersant; and preparing the T-ZnOw dispersion system after 10-60 min' stirring and 10-30 min' ultrasonic vibration;
b) adding the rare-earth element to the T-ZnOw dispersion system under ultrasound conditions; obtaining the rare-earth modified T-ZnOw suspension system after 10-60 min' stirring and 10-30 min' ultrasonic vibration; and
c) filtering, washing, drying, baking, and grinding the obtained rare-earth modified T-ZnOw suspension system to obtain a powdery product of a rare-earth modified T-ZnOw antibacterial agent.

16. The method of claim 10, wherein
a) adding the tetrapod-shaped zinc oxide whisker in the dispersion medium; adjusting the pH value of a resulting solution to 3-12 with acetic acid, ammonia liquor, sodium hydroxide, or sodium carbonate; adding the dispersant; and preparing the T-ZnOw dispersion system after 10-60 min' stirring and 10-30 min' ultrasonic vibration;
b) adding the rare-earth element to the T-ZnOw dispersion system under ultrasound conditions; obtaining the rare-earth modified T-ZnOw suspension system after 10-60 min' stirring and 10-30 min' ultrasonic vibration; and
c) filtering, washing, drying, baking, and grinding the obtained rare-earth modified T-ZnOw suspension system to obtain a powdery product of a rare-earth modified T-ZnOw antibacterial agent.

17. The method of claim 15, wherein
a) a weight percent of the tetrapod-shaped zinc oxide whisker in the antibacterial agent is between 0.5 and 20%;
b) a weight percent of the rare-earth element doped in the tetrapod-shaped zinc oxide whisker is between 0.0010 and 1.0000%;
c) a weight percent of the dispersant in the antibacterial agent is between 0.01 and 40%; and
d) rest component is the dispersion medium.

18. The method of claim 15, wherein the rare-earth element is La, Ho, Ce, Y, Pr, Gd, Dy, Eu, or a mixture thereof, and a chemical form of the rare-earth element is a chloride, oxide, sulfide, acetate, organic metal pure salt.

19. The method of claim 16, wherein the rare-earth element is La, Ho, Ce, Y, Pr, Gd, Dy, Eu, or a mixture thereof, and a chemical form of the rare-earth element is a chloride, oxide, sulfide, acetate, organic metal pure salt.

20. The method of claim 15, wherein the dispersion medium is deionized water, acetone, ethylene, or methanol, and the dispersant is PEG, titanate, polyacrylamide, sodium oleate, polyethylene, pyrrolone, triethanolamine, or a mixture thereof.
